(19) United States
(12) Patent Application Publication
(10) Pub. No.: US 2018/0240074 A1
(43) Pub. Date: Aug. 23, 2018

(54) Method of Automatically Applying to Job Postings

(71) Applicant: 133T, Germantown, MD (US)

(72) Inventor: Karim Harvey, Germantown, MD (US)

(21) Appl. No.: 15/901,854

(22) Filed: Feb. 21, 2018

Related U.S. Application Data
(60) Provisional application No. 62/461,631, filed on Feb. 21, 2017.

(51) Int. Cl. G06Q 10/10; G06F 17/30

(52) U.S. Cl. CPC G06Q 10/1053; G06F 17/30864

(57) ABSTRACT

A method of automatically applying to job postings requires at least one remote server, a user personal computing (PC) device, and an employer PC device. The method begins by prompting a user account to upload a resume and automated search criteria through the user PC device. The resume and the automated search criteria are relayed from the user PC device to the remote server. A professional profile is generated for the user account with the remote server. The automated search criteria are compared to each job posting with the remote server, thereby identifying at least one matching posting from a plurality of job postings. An application submission process is executed for the matching posting between the user account and a corresponding employer account. An application notification is sent to the user PC device, if the set of job requirements for the matching posting is met by the professional profile.

The current application claims priority to U.S. provisional application Ser. No. 62/461,631 filed on Feb. 21, 2017.

### FIELD OF THE INVENTION

The present invention generally relates to automated job application submission.

More specifically, the present invention automatically applies to job postings based on a specific set of desired criteria.

### BACKGROUND OF THE INVENTION

Applying for jobs is a time-consuming process that requires energy and demands consistency in order to get a job or even a response from employers. The job application process is time-consuming because an applicant has to thoroughly read each job description and determine whether he or she is actually qualified. Applicants also have to constantly be aware of new job postings. The job application process requires energy as the applicants have to submit an application as soon as possible in order to increase his or her chances to get considered by an employer. The job application process demands consistency as the applicant has to update his or her information diligently and be aware of any requirements necessary to better qualify for the job.

The objective of the present invention is to simplify the job application process while maximizing the chances of an applicant to get considered by an employer or preferably get a job offer. The present invention provides a better, wholistic presentation of an applicant. The present invention actively updates the applicant, providing employers with the most accurate information regarding the applicant, without the applicant having to worry about missing documents and outdated information. The present invention constantly compares the qualifications of the applicant with the requirements of job postings in order to submit an application as soon as possible. The present invention allows a variety of applicants to apply as the present invention requires a minimum percentage of similarity between the qualifications of an applicant and the job requirements.

### BRIEF DESCRIPTION OF THE DRAWINGS

FIG. 1 is a schematic view for a system of the present invention.

FIG. 2 is a flowchart illustrating the overall process for the present invention.

FIG. 3 is a flowchart illustrating the process for appending the supplemental professional document into the professional profile with the remote server of the present invention.

FIG. 4 is a flowchart illustrating the process for appending the set of professional skills into the professional profile with the remote server of the present invention.

FIG. 5 is a flowchart illustrating the process for displaying the set of summarization details through the employer PC device of a specific employer account of the present invention.

FIG. 6 is a flowchart illustrating the process for executing an application submission process for the matching posting between the user account and the corresponding employer account of the present invention.

FIG. 7 is a flowchart illustrating the process for displaying a plurality of posting management options for each applied posting through the user PC device of the present invention.

FIG. 8 is a flowchart illustrating the process for executing the desired option on the specific posting with the remote serve of the present invention, wherein the desired option is a freeze option.

FIG. 9 is a flowchart illustrating the process for executing the desired option on the specific posting with the remote serve of the present invention, wherein the desired option is a restart option.

FIG. 10 is a flowchart illustrating the process for executing the desired option on the specific posting with the remote serve of the present invention, wherein the desired option is a delete option.

FIG. 11 is a flowchart illustrating the process for displaying a progress notification and a plurality of posting management options for each applied posting through the user PC device of the present invention.

FIG. 12 is a flowchart illustrating the process for executing the desired option on the specific posting with the remote server of the present invention.

FIG. 13 is a flowchart illustrating the process for relaying the missing data from the user PC device to the remote server of the present invention.

FIG. 14 is a flowchart illustrating the process executing the desired option on the specific posting with the remote server of the present invention, with the missing data appended into the professional profile with the remote server.

FIG. 15 is a flowchart illustrating the process for prompting the user account to select at least one desired option for a specific posting with the user PC device of the present invention.

FIG. 16 is a flowchart illustrating the process for relaying the set of answers from the user PC device, through the remote server, and to the employer PC device of the present invention.

FIG. 17 is a flowchart illustrating the process for identifying the matching posting from the plurality of job postings during step (F) of the present invention.

### DETAIL DESCRIPTIONS OF THE INVENTION

All illustrations of the drawings are for the purpose of describing selected versions of the present invention and are not intended to limit the scope of the present invention.

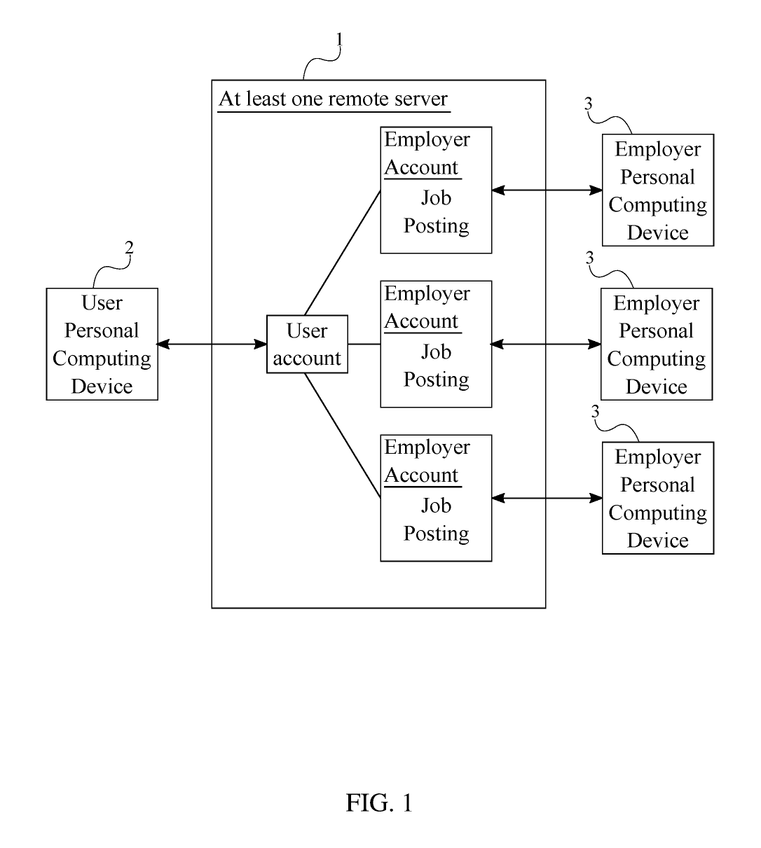

The present invention is a method of automatically applying to job postings. The present invention is used to automatically apply to job postings based on a desired set of criteria such as job type, job requirements, location, and so on. The present invention provides notifications based on the status of the application and any required input. Such input may include, but is not limited, to documentation and information. Thus, the physical system used to implement the method of the present invention includes at least one remote server 1, a user personal computing (PC) device 2, and an employer PC device 3, as illustrated in FIG. 1. The at least one remote server 1 manages a user account, a plurality of employer accounts, and a plurality of job postings. The user account is associated to the user PC device 2 (Step A). The user PC device 2 communicates with the plurality of employer accounts through the at least one remote server 1. Each job posting is associated with a corresponding employer account from the plurality of employer accounts. Moreover, each employer account is associated to an employer PC device 3, and each job posting includes a set of job requirements (Step B). The user PC device 2 is preferably a smart phone that utilizes the speaker, the microphone, the display screen, and the processing unit of the smart phone. In alternate embodiments of the present invention, the user PC device 2 may include a variety of other smart devices such as smart home devices, smart watches and so on.

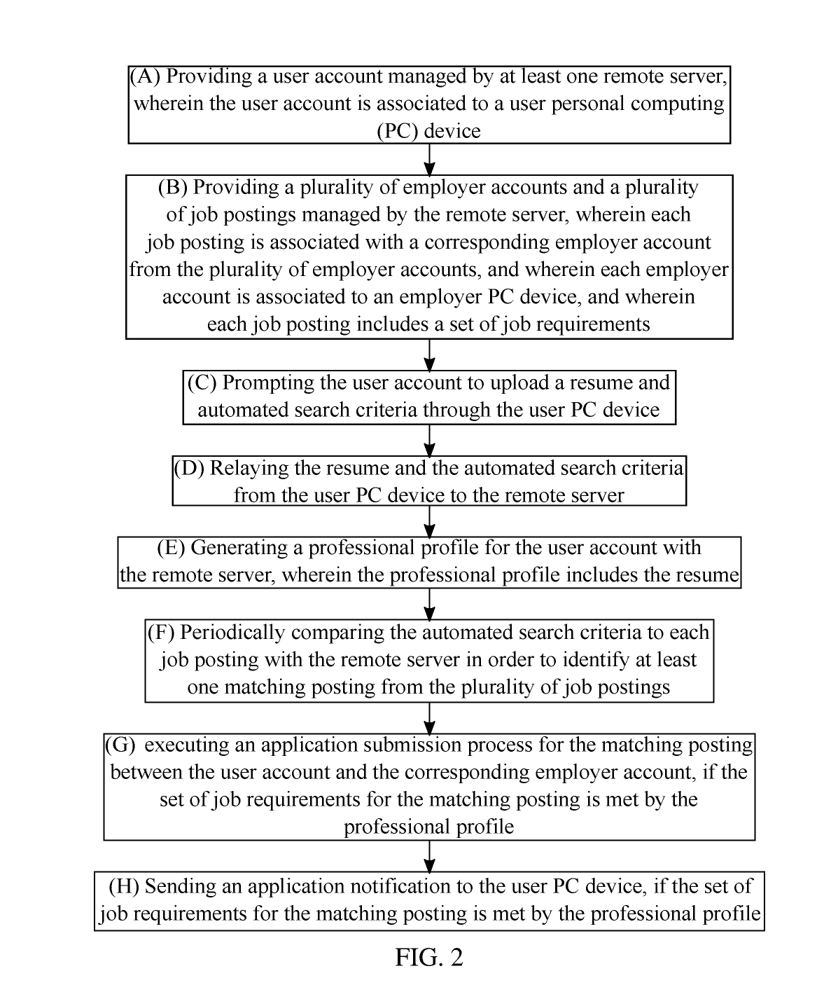

The overall process for the present invention includes the following steps that are implemented with the at least one remote server 1, the user PC device 2, and the employer PC device 3. As shown in FIG. 2, the overall process begins by prompting the user account to upload a resume and automated search criteria through the user PC device 2 (Step C). The user PC device 2 utilizes the display screen, which is preferably a touch-activated screen, the microphone, and the speaker in order to upload the resume and automated search criteria. More specifically, the user may engage the display screen like that of a smart phone. The user may engage the microphone and speaker like that of a smart home device or a smart phone as well. The resume defines the user account, and the automated search criteria provides the user account with desired job postings. The resume and automated search criteria is relayed from the user PC device 2 to the remote server 1 (Step D) in order to associate the uploaded resume and automated search criteria with the user account. A professional profile is generated for the user account with the remote server 1, wherein the professional profile includes the resume (Step E). The professional profile provides the necessary information to the plurality of employer accounts for automatic job application. The automated search criteria are periodically compared to each job posting with the remote server 1 in order to identify at least one matching posting from the plurality of job postings (Step F), in order to provide the desired job postings to the user account. The present invention automatically applies to job postings as an application submission process is executed for the matching posting between the user account and the corresponding employer account, if the set of job requirements for the matching posting is met by the professional profile (Step G). An application notification is sent to the user PC device 2, if the set of job requirements for the matching posting is met by the professional profile (Step H). The application notification may be an alert of the user PC device 2 or preferably an email associated with the user account. The application notification alerts of the completion of the application submission process.

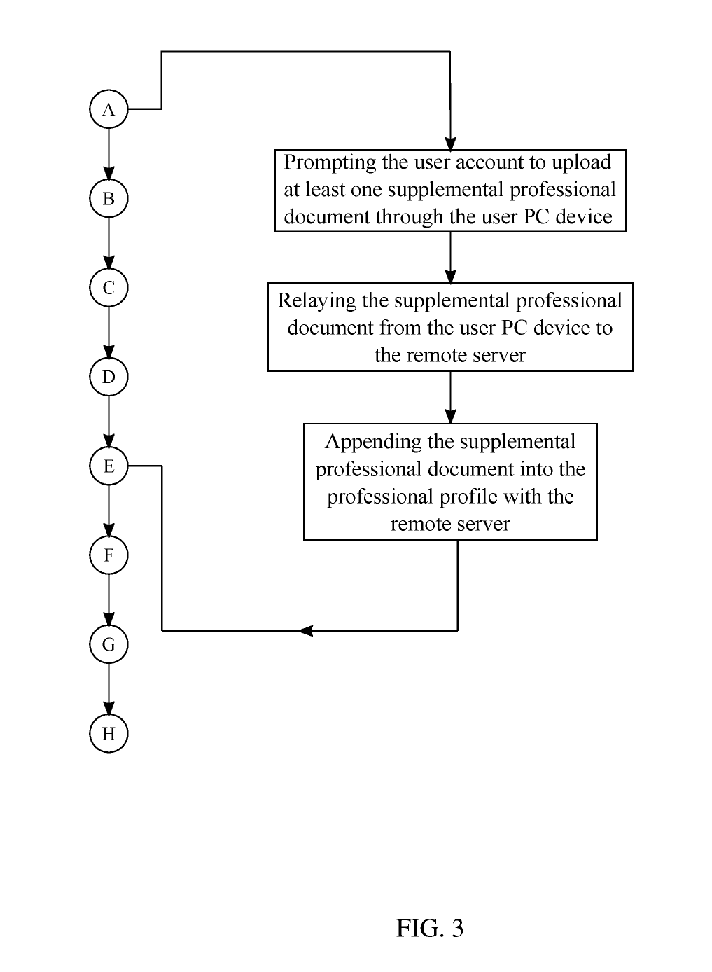

The user account may be defined in a variety of ways in order to provide the plurality of employer accounts with a wide selection of qualified user accounts, as well as provide an accurate and unique representation of each user account. This wide selection of qualified user accounts allows each employer account to accurately select the user account that best satisfies the set of job requirements. As shown in FIG. 3, the user account may further be defined as the user account is prompted to upload at least one supplemental professional document through the user PC device 2. The at least one supplemental professional document provides further information that corresponds to the user account. The at least one supplemental professional document narrows the matching postings and provides the plurality of employer accounts with a more accurate application submission process. The at least one supplemental professional document may include, but is not limited to, cover letters, recommendations, and certifications. Similar to that of the resume, the supplemental professional document is relayed from the user PC device 2 to the remote server 1, thereby associating the uploaded supplemental professional document with the user account. The supplemental professional document is then appended into the professional profile with the remote server 1, further defining the user account among other user accounts.

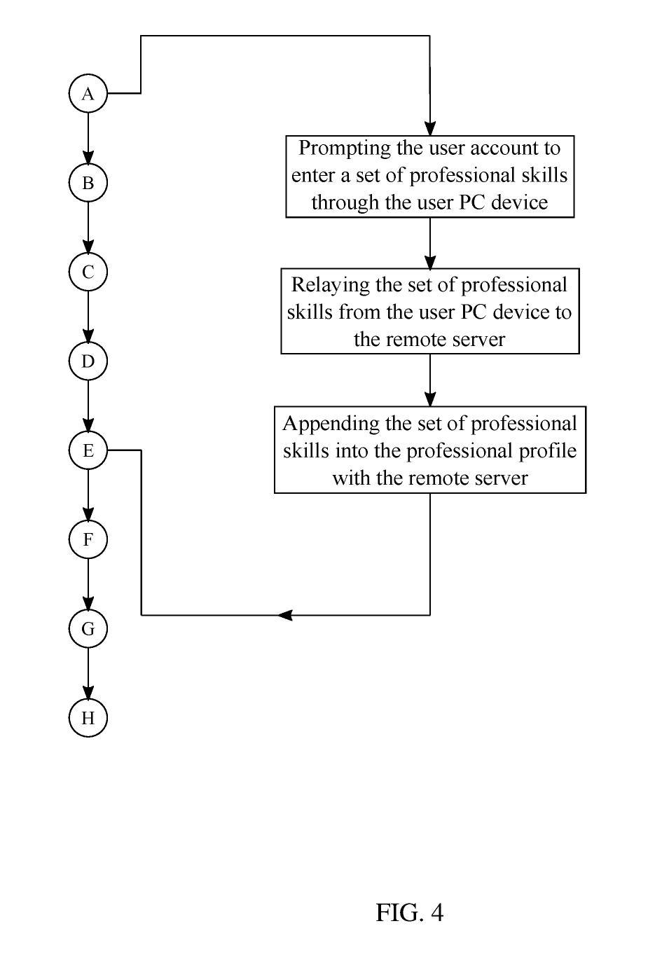

As shown in FIG. 4, the user account may further be defined as the user account is prompted to enter a set of professional skills through the user PC device 2. The set of professional skills may include, but is not limited to, technical skills, managerial skill, and communication skills. The set of professional skills allows the plurality of employer accounts to effectively and efficiently compare the professional profile of the user account with the set of job requirements. Similar to that of the resume and the at least one supplemental professional document, the set of professional skills is relayed form the user PC device 2 to the remote server 1, thereby associating the uploaded set of professional skills with the user account. The set of professional skills is appended into the professional profile with the remote server 1, further defining the user account among other user accounts.

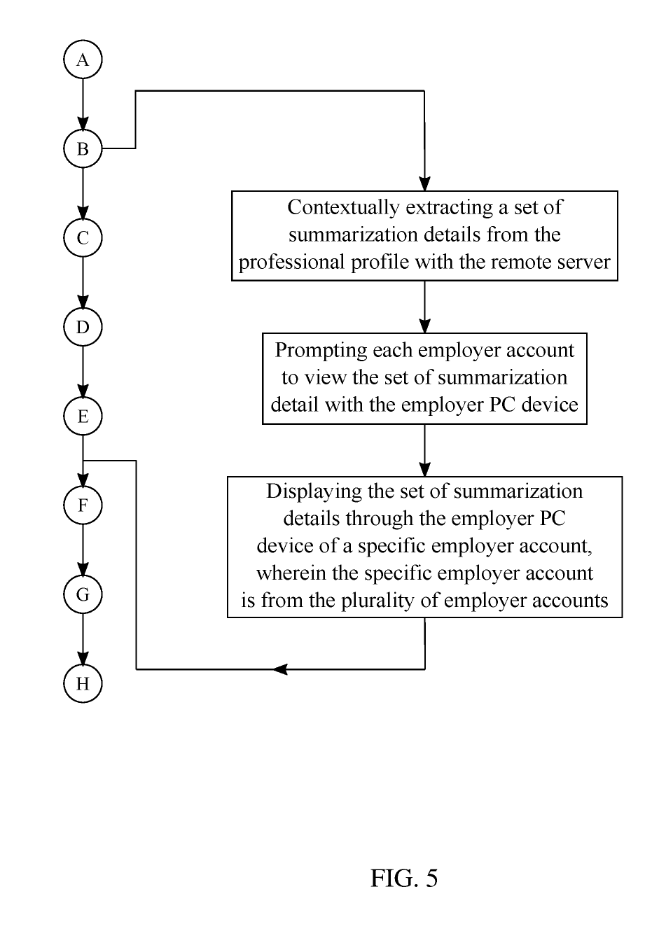

The user account may be assessed by each of the employer accounts while the automated search criteria of the user account is compared to each job posting and the application submission process is executed. As seen in FIG. 5, this assessment begins as a set of summarization details is contextually extracted from the professional profile with the remote server 1. The set of summarization details provides basic information associated with the user account in order for the plurality of employer accounts to quickly filter through the user account among other user accounts. Each employer account is prompted to view the set of summarization details with the employer PC device 3. The user account is able to be assessed as the set of summarization details is displayed through the employer PC device 3 of a specific employer account, wherein the specific employer is from the plurality of employer accounts.

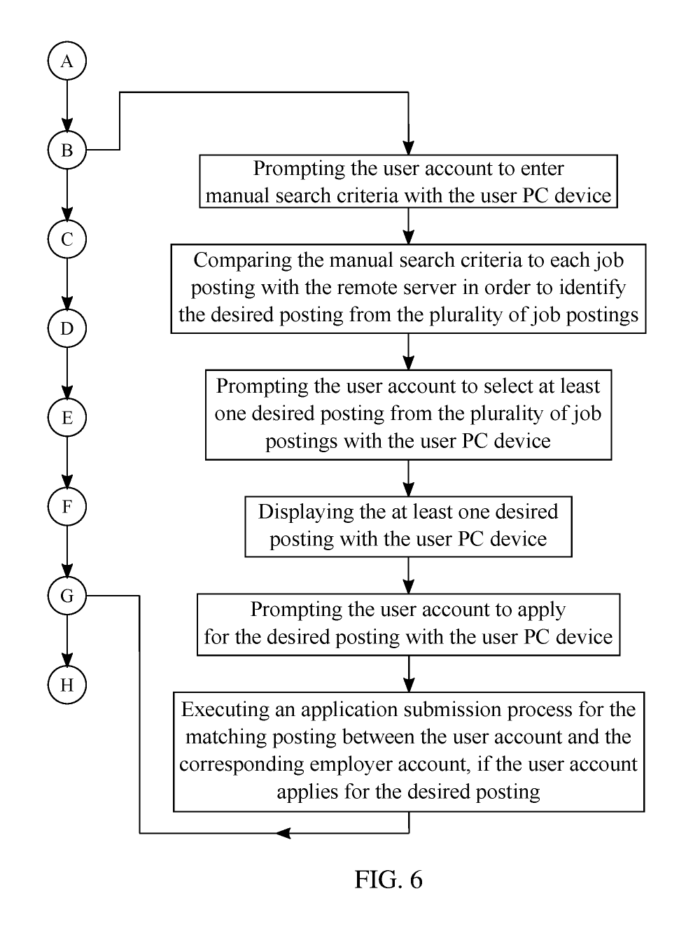

A job posting may be purposefully selected by the user account such that the application submission process is executed for the selected job posting. In order for a job posting to be purposefully selected, the user account is prompted to select at least one desired posting from the plurality of job postings with the user PC device 2, as seen in FIG. 6. The at least one desired posting is displayed with the user PC device 2, and the user account is prompted to apply for the desired posting with the user PC device 2. An application submission process is executed for the matching posting between the user account the corresponding employer account, if the user account applies for the desired posting. This application submission process allows the desired job posting to be purposefully selected before and during the automated search criteria is periodically compared with the remote server 1. In order to filter through the job postings and execute the application submission process for the desired posting, the user account is prompted to enter manual search criteria with the user PC device 2. The manual search criteria may include automated search criteria; however, the manual search criteria preferably include additional criteria or more specific criteria that warrants the purposeful entry. The manual search criteria are compared to each job posting with the remote server 1 in order to identify the desired posting from the plurality of job postings.

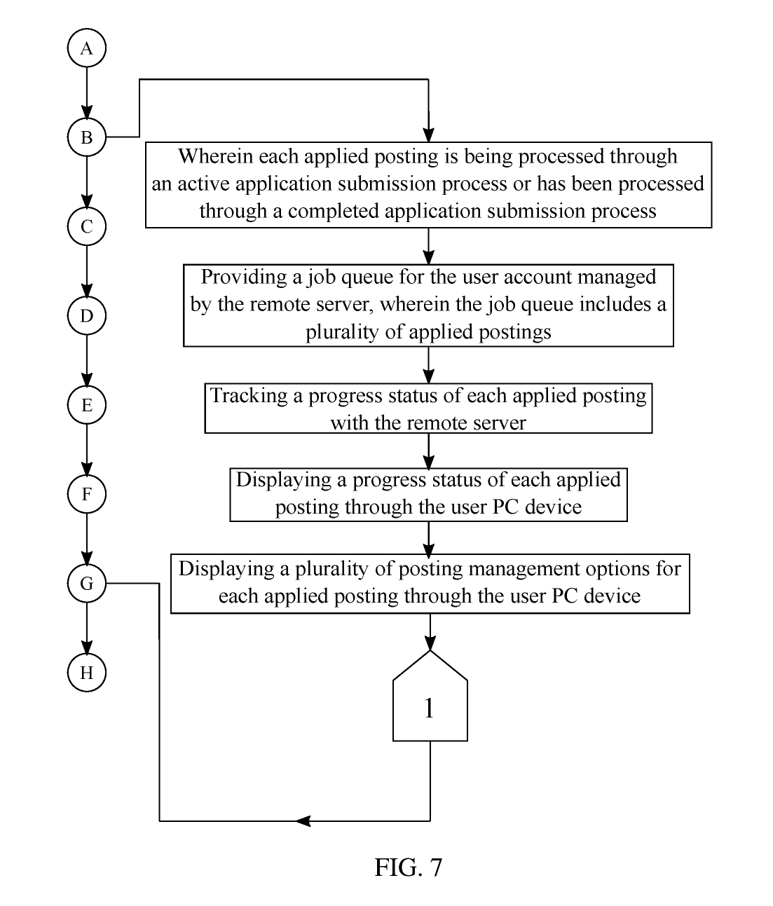

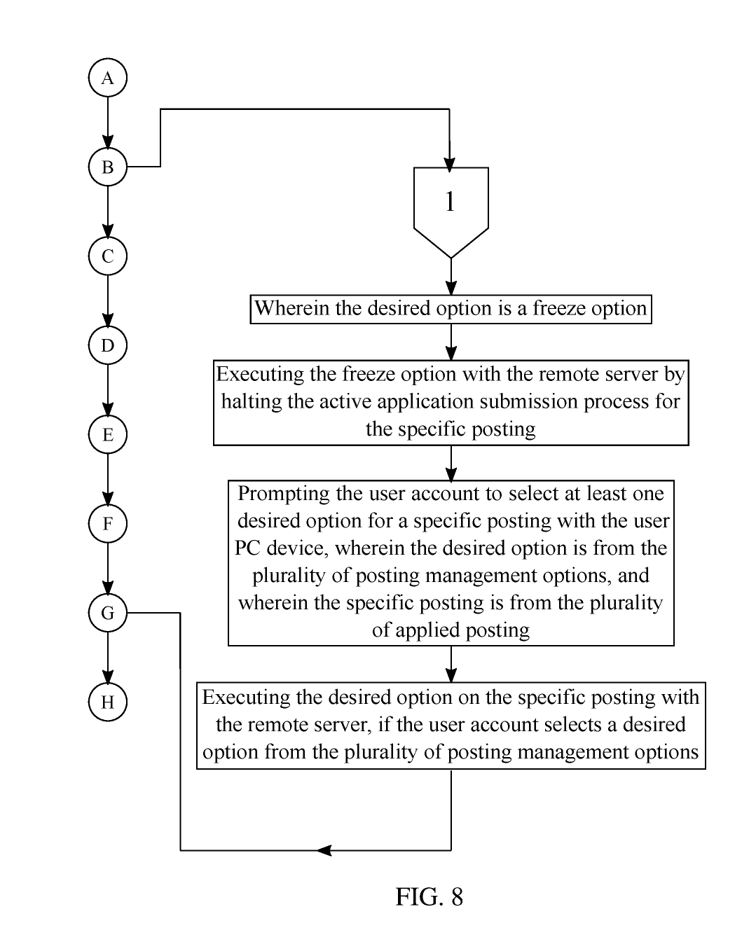

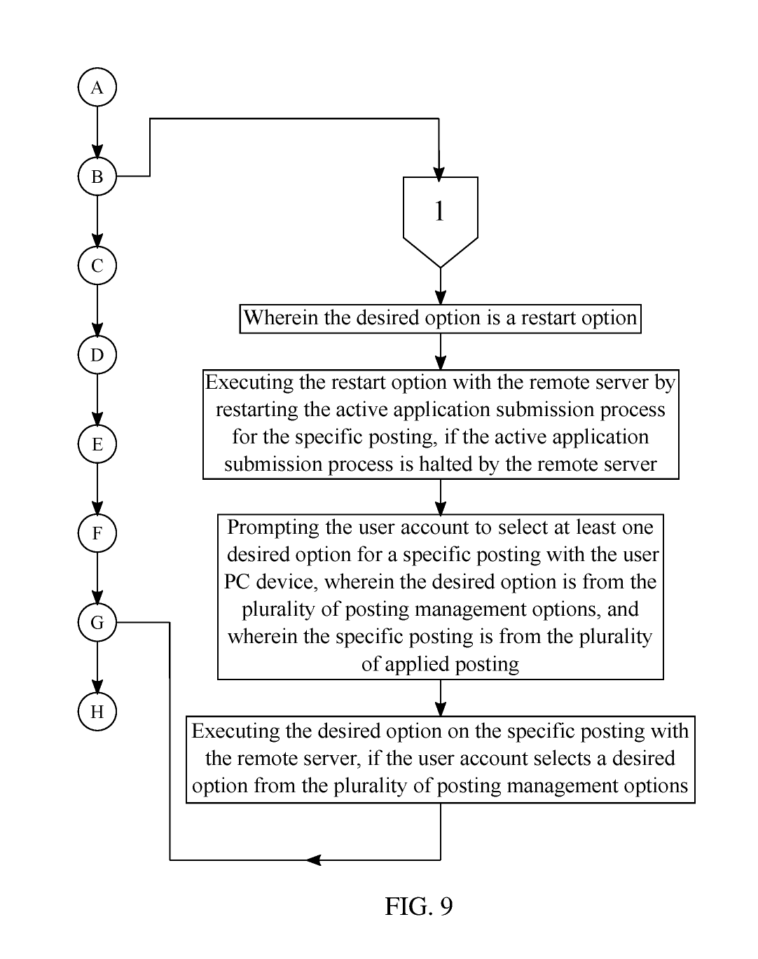

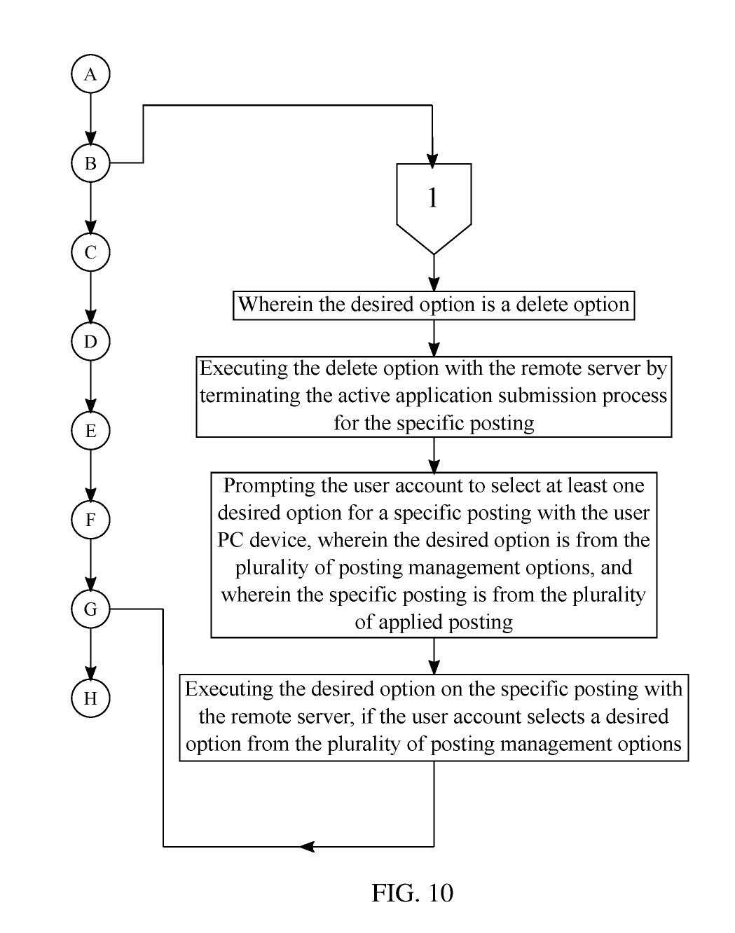

In order to manage matching postings and desired postings of plurality of job postings, a job queue is provided for the user account managed by the remote server 1, as seen in FIG. 7, FIG. 8, FIG. 9, and FIG. 10. Each applied posting is processed through an active application submission process or has been processed through a completed application submission process. The job queue categorizes and organizes each applied posting, facilitating the referencing, filtering, and managing of each applied posting. A progress status of each applied posting is tracked with the remote server 1 and is displayed through the user PC device 2. The progress status allows job queue to be organized by the status of the application submission process. A plurality of posting management options is displayed for each applied posting through the user PC device 2.

The posting management options allows the user account to control the application submission process. The user account is prompted to select at least one desired option for a specific posting with the user PC device 2, wherein the desired option is from the plurality of posting management options, and wherein the specific posting is from the plurality of applied postings. The desired option of the specific posting is executed with the remote server 1, if the user account selects a desired option from the plurality of posting management options, and the application submission process of the specific posting is altered accordingly.

The application submission process of the specific posting may be put on hold, wherein the desired option is a freeze option, shown in FIG. 8. The freeze option prevents the application submission process from continuing without deleting any progress of the application submission process. In order to put the application submission process on hold, the freeze option is executed with the remote server 1 by halting the active application submission process for the specific posting. Regardless of the progress status of the specific posting, the application submission process may begin over, wherein the desired option is a restart option, shown in FIG. 9. The restart option deletes all progress of the application submission process and begins the application submission process with any updates of the professional profile. In order to begin over the application submission process, the restart option is executed with the remote server 1 by restarting the active application submission process for the specific posting, if the active application process is halted by the remote server 1. In the event, the application submission process of the specific posting does not need to continue, the specific posting may be deleted, wherein the desired option is a delete option, shown in FIG. 10. The delete option deletes any progress of the application submission process and the specific posting from the plurality of applied postings. In order to remove the specific posting from the plurality of applied postings, the delete option is executed with the remote server 1 by terminating the active application submission process for the specific posting.

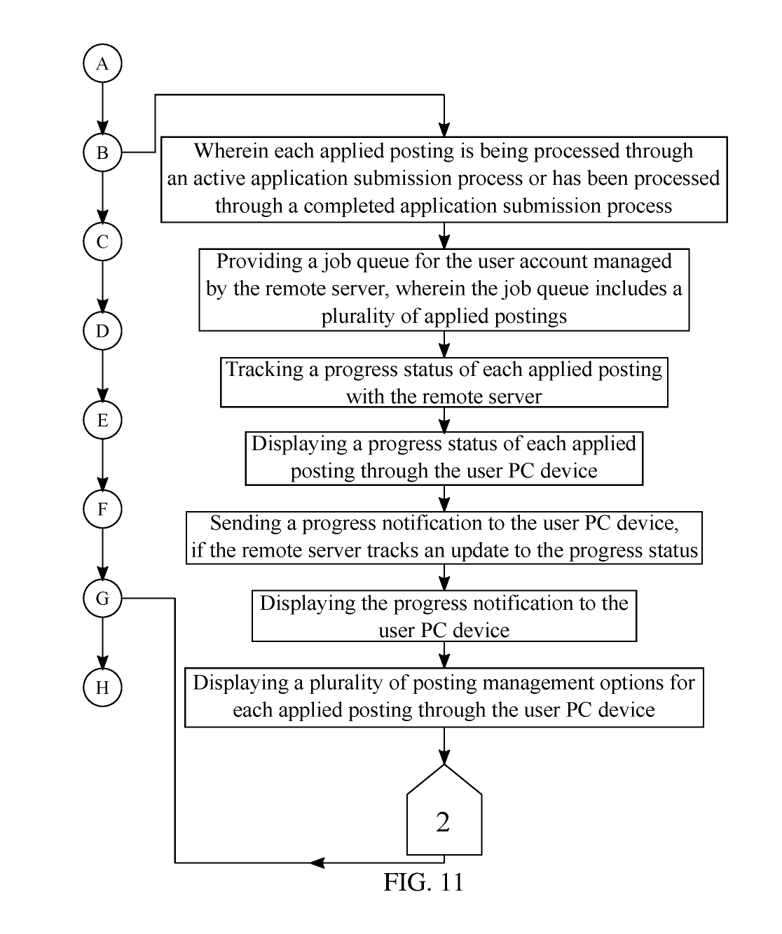

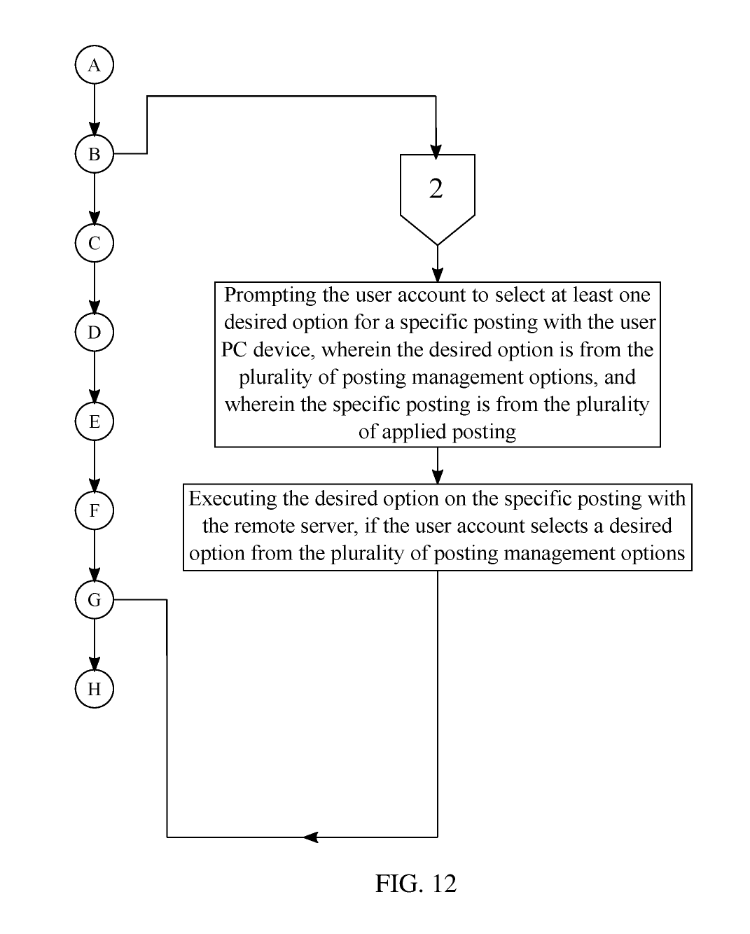

As shown in FIG. 11 and FIG. 12, the application submission process is automatically, accurately, and efficiently completed as a progress notification is sent to the user PC device 2, if the remote server 1 tracks an update to the progress status. The progress notification presents an alert of the progress status of the application submission process. This allows the execution of the freeze option, the restart option, and the delete option to be executed at an appropriate point in time along the application submission process. No option may be executed as well if the selected posting and the progress notification serves to purely deliver information regarding the progress status. The progress notification is displayed to the user PC device 2.

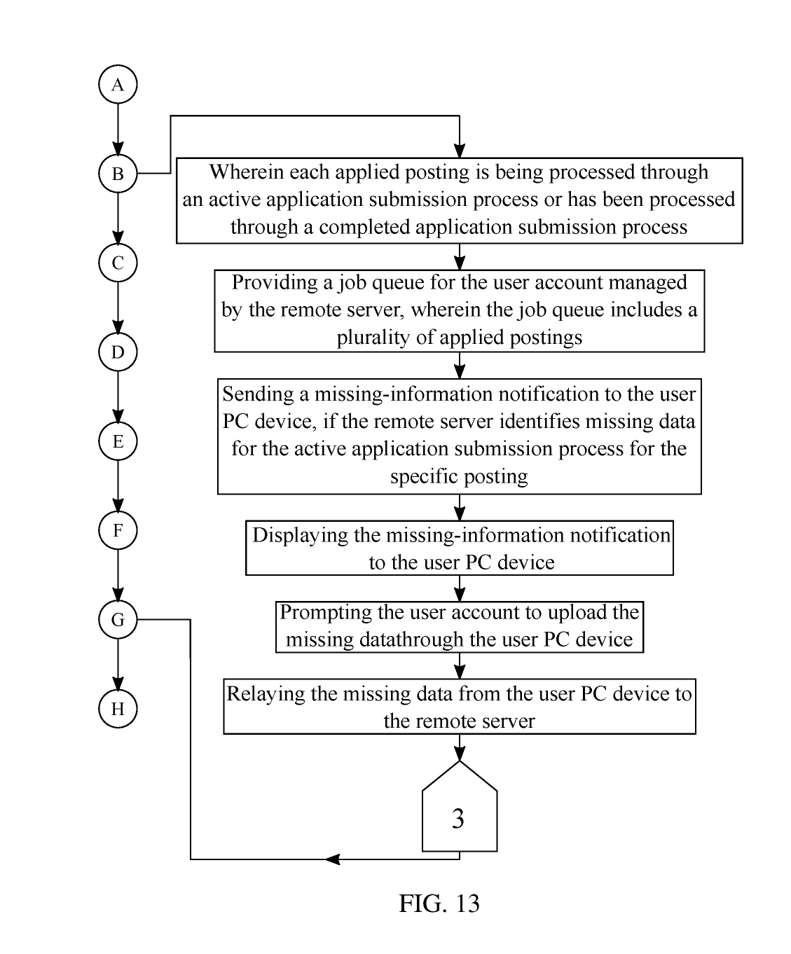

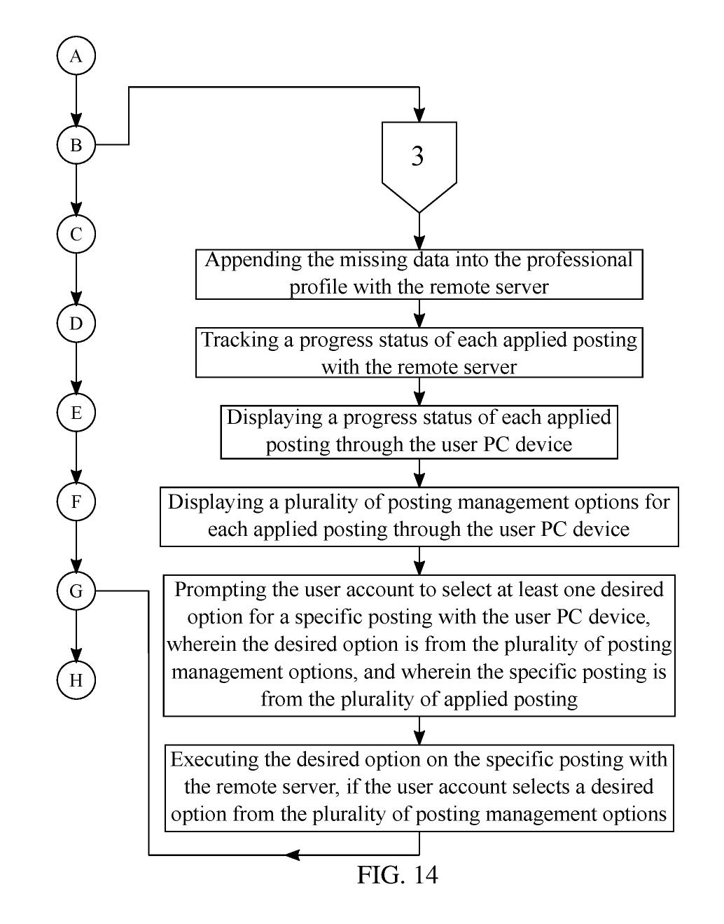

In order to account for the fulfillment of the set of job requirements for the specific posting by the user account, a missing-information notification is sent to the user PC device 2, if the remote server 1 identifies missing data for the active application submission process for the specific posting, as seen in FIG. 13 and FIG. 14. The missing-information notification may account for an at least one supplemental professional document, a skill from a set of professional skills, and any other information from the professional profile of the user account. The missing-information notification is displayed to the user PC device 2, and the user account is prompted to upload the missing data through the user PC device 2. This allows the application submission process to proceed without the user account having to manually check if any data is missing which leaves the application of the user account incomplete or put on hold. The missing data is relayed from the user PC device 2 to the remote server 1, and the missing data is then appended into the professional profile with the remote server 1. The application submission process and the application of the user account is complete and accurate. In the event, the user account does not upload the missing data, the application submission process may be halted or continue depending on the job requirements of the job posting. The corresponding employer account selects for each job requirement, if the job requirement is essential to the job posting or optional.

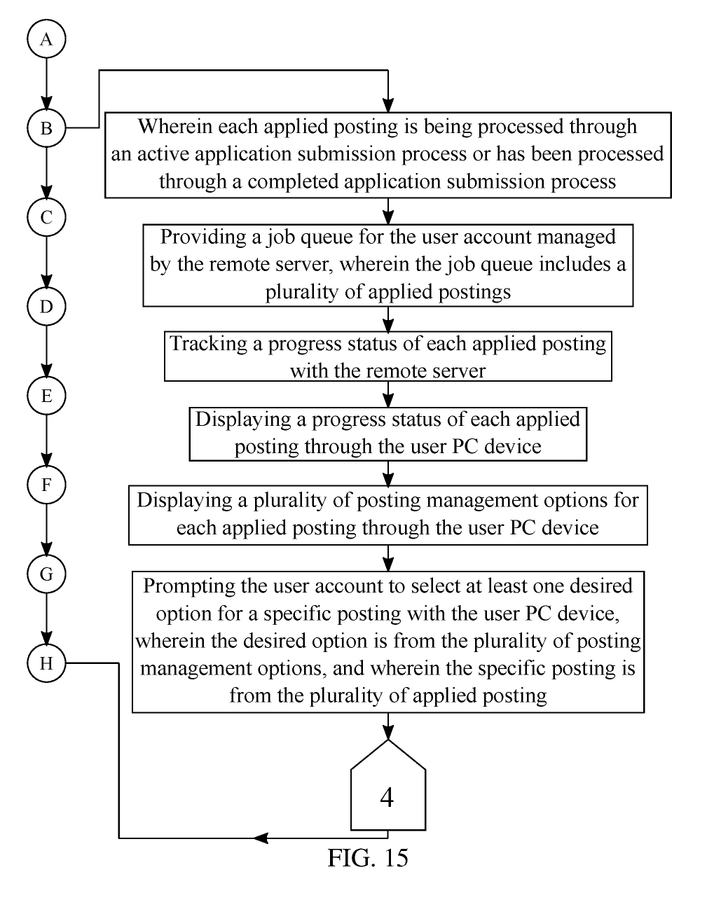

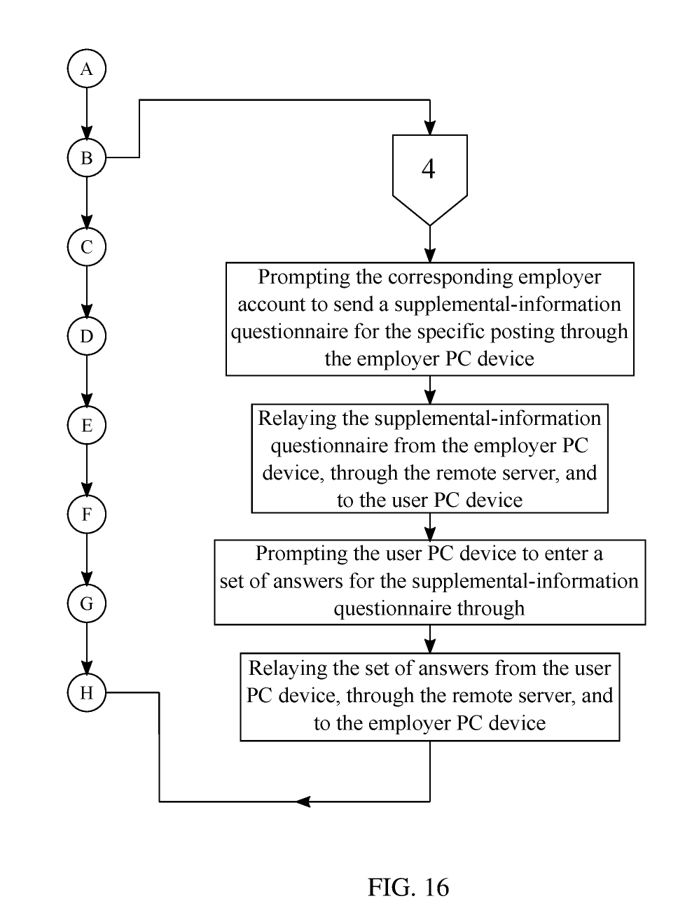

Throughout the application submission process, preferably upon the completion the application process, the employer account may require standard employment information from the user account. More specifically, the corresponding employer account is prompted to send a supplemental-information questionnaire for the specific posting through the employer PC device 3, as seen in FIG. 15 and FIG. 16. The standard employment information is delivered from the user account through the user PC device 2 to the employer account with the supplemental-information questionnaire. The supplemental-information questionnaire is relayed from the employer PC device 3, through the remote server 1, and to the user PC device 2 in order for the user account to deliver standard employment information to the employer account with the supplemental-information questionnaire. The user PC device 2 is prompted to enter a set of answers for the supplemental-information questionnaire through the user PC device 2. The set of answers provides the desired standard employment information by the employer account. The set of answers is relayed from the user PC device 2, through the remote server 1, and to the employer PC device 3, so that the employer account is able to review and process the set of answers and review the application of the user account thoroughly and accurately.

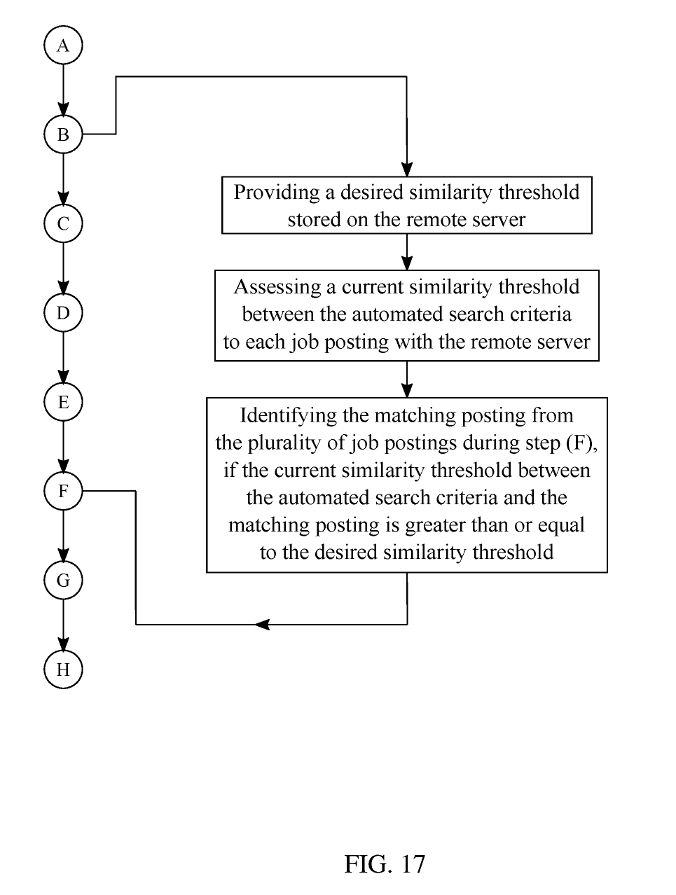

In order for the professional profile of the user account to be compared to the job requirements of a job posting, a desired similarity threshold stored on the remote server 1 is provided, as shown in FIG. 17. The desired similarity threshold facilitates the filtering of the user account and other user accounts for the corresponding employer account. A current similarity threshold is assessed between the automated search criteria to each job posting with the remote server 1, and the matching posting is identified from the plurality of job postings during Step F. This identification occurs only if the current similarity threshold between the automated search criteria and the matching posting is greater than or equal to the desired similarity threshold.

Although the invention has been explained in relation to its preferred embodiment, it is to be understood that many other possible modifications and variations can be made without departing from the spirit and scope of the invention as hereinafter claimed.

What is claimed is:

1. A method of automatically applying to job postings, the method comprises the steps of:
(A) providing a user account managed by at least one remote server, wherein the user account is associated to a user personal computing (PC) device;
(B) providing a plurality of employer accounts and a plurality of job postings managed by the remote server, wherein each job posting is associated with a corresponding employer account from the plurality of employer accounts, and wherein each employer account is associated to an employer PC device, and wherein each job posting includes a set of job requirements;
(C) prompting the user account to upload a resume and automated search criteria through the user PC device;
(D) relaying the resume and the automated search criteria from the user PC device to the remote server;
(E) generating a professional profile for the user account with the remote server, wherein the professional profile includes the resume;
(F) periodically comparing the automated search criteria to each job posting with the remote server in order to identify at least one matching posting from the plurality of job postings;
(G) executing an application submission process for the matching posting between the user account and the corresponding employer account, if the set of job requirements for the matching posting is met by the professional profile; and,
(H) sending an application notification to the user PC device, if the set of job requirements for the matching posting is met by the professional profile.

2. The method of automatically applying to job postings, the method as claimed in 1 comprises the steps of:
prompting the user account to upload at least one supplemental professional document through the user PC device;
relaying the supplemental professional document from the user PC device to the remote server; and,
appending the supplemental professional document into the professional profile with the remote server.

3. The method of automatically applying to job postings, the method as claimed in 1 comprises the steps of:
prompting the user account to enter a set of professional skills through the user PC device;
relaying the set of professional skills from the user PC device to the remote server; and,
appending the set of professional skills into the professional profile with the remote server.

4. The method of automatically applying to job postings, the method as claimed in 1 comprises the steps of:
contextually extracting a set of summarization details from the professional profile with the remote server;
prompting each employer account to view the set of summarization details with the employer PC device; and,
displaying the set of summarization details through the employer PC device of a specific employer account, wherein the specific employer account is from the plurality of employer accounts.

5. The method of automatically applying to job postings, the method as claimed in 1 comprises the steps of:
prompting the user account to select at least one desired posting from the plurality of job postings with the user PC device;
displaying the at least one desired posting with the user PC device;
prompting the user account to apply for the desired posting with the user PC device; and,
executing an application submission process for the matching posting between the user account and the corresponding employer account, if the user account applies for the desired posting.

6. The method of automatically applying to job postings, the method as claimed in 5 comprises the steps of:
prompting the user account to enter manual search criteria with the user PC device; and,
comparing the manual search criteria to each job posting with the remote server in order to identify the desired posting from the plurality of job postings.

7. The method of automatically applying to job postings, the method as claimed in 1 comprises the steps of:
providing a job queue for the user account managed by the remote server, wherein the job queue includes a plurality of applied postings, wherein each applied posting is being processed through an active application submission process or has been processed through a completed application submission process;
tracking a progress status of each applied posting with the remote server;
displaying a progress status of each applied posting through the user PC device;
displaying a plurality of posting management options for each applied posting through the user PC device;
prompting the user account to select at least one desired option for a specific posting with the user PC device, wherein the desired option is from the plurality of posting management options, and wherein the specific posting is from the plurality of applied postings; and,
executing the desired option on the specific posting with the remote server, if the user account selects a desired option from the plurality of posting management options.

8. The method of automatically applying to job postings, the method as claimed in 7 comprises the steps of:
wherein the desired option is a freeze option; and,
executing the freeze option with the remote server by halting the active application submission process for the specific posting.

9. The method of automatically applying to job postings, the method as claimed in 7 comprises the steps of:
wherein the desired option is a restart option; and,
executing the restart option with the remote server by restarting the active application submission process for the specific posting, if the active application submission process is halted by the remote server.

10. The method of automatically applying to job postings, the method as claimed in 7 comprises the steps of:
wherein the desired option is a delete option; and,
executing the delete option with the remote server by terminating the active application submission process for the specific posting.

11. The method of automatically applying to job postings, the method as claimed in 7 comprises the steps of:
sending a progress notification to the user PC device, if the remote server tracks an update to the progress status; and
displaying the progress notification to the user PC device.

12. The method of automatically applying to job postings, the method as claimed in 7 comprises the steps of:
sending a missing-information notification to the user PC device, if the remote server identifies missing data for the active application submission process for the specific posting;
displaying the missing-information notification to the user PC device;
prompting the user account to upload the missing data through the user PC device; and,
relaying the missing data from the user PC device to the remote server;
appending the missing data into the professional profile with the remote server.

13. The method of automatically applying to job postings, the method as claimed in 7 comprises the steps of:
prompting the corresponding employer account to send a supplemental-information questionnaire for the specific posting through the employer PC device;
relaying the supplemental-information questionnaire from the employer PC device, through the remote server, and to the user PC device;
prompting the user PC device to enter a set of answers for the supplemental-information questionnaire through the user PC device; and,
relaying the set of answers from the user PC device, through the remote server, and to the employer PC device.

14. The method of automatically applying to job postings, the method as claimed in 1 comprises the steps of:
providing a desired similarity threshold stored on the remote server;
assessing a current similarity threshold between the automated search criteria to each job posting with the remote server; and,
identifying the matching posting from the plurality of job postings during step (F), if the current similarity threshold between the automated search criteria and the matching posting is greater than or equal to the desired similarity threshold.
